(19) United States
(12) Patent Application Publication
(10) Pub. No.: US 2012/0305549 A1
(43) Pub. Date: Dec. 6, 2012

(54) Microwave Oven Food Stirring Assembly

(76) Inventor: Phillip K. Wylie, Wellington, KS (US)

(21) Appl. No.: 13/328,521

(22) Filed: Dec. 16, 2011

Related U.S. Application Data
(60) Provisional application No. 61/492,949, filed on Jun. 3, 2011.

(51) Int. Cl. H05B 6/80; B01F 13/00

(52) U.S. Cl. 219/726; 366/343; 366/197; 366/200

(57) ABSTRACT

A microwave oven food stirring assembly including a dasher having an upper end, and having a lower surface; a rotary bearing, the rotary bearing including the dasher's lower surface; and a plurality of ties, each tie among the plurality of ties having a distal end and having a proximal end, each tie's proximal end being fixedly attached to the dasher's upper end; the dasher including an upper end “T” bracket and a bracket mounting non-circular pin and socket joint for fixedly attaching the “T” bracket at the dasher's upper end; the ties being downwardly anchored within the microwave oven for holding the dasher against the vessel floor and for resisting rotation of the dasher as the vessel is turned by the microwave oven's turntable.

### CLAIM OF PRIORITY FROM PREVIOUSLY FILED PROVISIONAL PATENT APPLICATION

This non-provisional patent application claims the benefit of and priority from U.S. provisional patent application No. 61/492,949 filed Jun. 3, 2011. The inventor disclosed in said provisional application is the same person as the person who is disclosed as the inventor in the instant application. The applicant asserts that structures and functions of structures disclosed and described in the instant application are in numerous respects similar to those described in said provisional application. For purposes of determining priority of claims whose subject matter constitutes new matter, the instant application should be treated as a continuation in part application.

### FIELD OF THE INVENTION

This invention relates to auxiliary apparatus and assemblies for use with food turning carousel equipped microwave ovens. More particularly, this invention relates to such apparatus and assemblies which are specially adapted and configured for stirring liquid and semi-liquid food items during cooking or warming within such microwave ovens.

### BACKGROUND OF THE INVENTION

Apparatus and assemblies in the nature of auxiliary equipment for adapting a microwave oven for continually stirring liquid food items during cooking are known. Such apparatus and assemblies commonly derive their motive force for stirring action from rotary powered carousels or turntables which are commonly installed as originally manufactured equipment within microwave ovens. However, such stirring assemblies are commonly mechanically complex, they are commonly are difficult to clean and sanitize, and they commonly ineffective and inefficiently stir food within a microwave oven, leaving food product near cooking vessel floors and walls unstirred. The instant inventive microwave oven food stirring assembly solves or ameliorates the problems, defects, and deficiencies noted above by providing specialized dasher, rotary bearing, and rotating resisting member assembly which effectively stirs liquid or semi-liquid food during warming or cooking within a microwave oven.

### BRIEF SUMMARY OF THE INVENTION

A first structural component of the instant inventive microwave oven food stirring assembly comprises a food stirring dasher. Where the food stirring dasher is intended for use within a particular microwavable bowl or other cooking vessel, the dasher's upper end preferably (for reasons further discussed below) extends to an upper elevation which overlies or exceeds the height of such vessel's peripheral wall.

In a preferred embodiment of the instant inventive assembly, the dasher element is specially configured to present an alternatively attachable and removable “T” bracket, such bracket having a plurality of arms. In a preferred embodiment, the dasher has a central vertical axis, and the “T” bracket portion of the dasher's upper end forms a pair of cantilevering arms which extend outwardly and radially oppositely from that axis. While the upper “T” bracket portion of the dasher element may be suitably formed wholly with underlying portions of the dasher, or may be suitably rigidly attached, such “T” bracket portion preferably comprises a rotation stopping hold down bar which is removably attached by means of a central pin and socket joint. Where such “T” bracket attaching joint is provided, the pin and socket preferably have a matching non-circular cross-sectional geometries which facilitate vertical attachments and removals of the bar, and which constrain the “T” bracket bar against any rotation about the vertical axis with respect to underlying portions of the dasher.

In a preferred embodiment, the dasher comprises a pair of plates which form food stirring vanes. Preferably, the plates may be assembled together to assume a stabilizing “X” base configuration, the interconnection between the plates preferably comprising a pair of opposing and nesting slots. Where the dasher is intended for use for stirring liquid or semi-liquid food within a circular microwavable food cooking vessel, at least one of the radially outer surfaces of the plates' outwardly extending vanes is preferably closely fitted to orbit over such vessel's inner wall surface. Upon rotation of the vessel, such fitted outer edge of the dasher effectively stirs food material residing at the wall of the vessel. Suitably, all of the dasher's radially outer edges may be closely fitted to the circumferentially inner periphery of such vessel.

For further enhancement of the dasher's food stirring capability, a plurality of flow through ports preferably extend through the dasher's food stirring vanes.

A further structural component of the instant inventive microwave oven food stirring assembly comprises a rotary bearing surface, such surface preferably comprising lower or underlying surfaces of the vanes of the preferably “X” configured dasher. In operation of such rotary bearing, the undersurfaces of such dasher vanes may be supported against and may slide along the upper surface of the floor of the vessel into which the dasher is nestingly inserted. Such bearing usage, such vessel's floor surface correspondingly functions as a part of the rotary bearing which facilitates controlled relative rotation of the vessel with respect to the dasher.

Upon disassembly of the slot connected dasher components, the disassembled plates may be conveniently washed within a common dishwasher, the dasher's separate plates being stacked within a dishwasher rack in the manner of common food serving plates.

A further structural component of the instant inventive microwave oven food stirring assembly comprises rotation resisting members which are preferably configured as a plurality of ties having proximal ends attached at radially opposite ends of the dasher's upper end. Where the dasher's upper end is configured, as is preferred, to present a “T” bar, the proximal ends of the ties are preferably fixedly attached to eyes provided at the distal ends of the “T” bar's arms. Each tie preferably comprises an elastomeric band.

In use of the instant inventive microwave oven food stirring assembly, and assuming a provision of the preferred structures described above, the assembled dasher element may be initially inserted into a cooking vessel which contains a liquid or semi-liquid food item which is to be continuously stirred during cooking or warming within a microwave oven. Thereafter, such assembled vessel, food item, and dasher combination may be placed upon the microwave oven's carousel turntable. In the event that the microwave oven lacks an OEM turntable, the user of the instant inventive assembly may provide a portable microwavable rotary powered turntable.

Wall hooks are preferably provided for adhesive attachment to the microwave oven's opposite interior side walls, such hooks facilitating removable attachments of the distal ends of the assembly's ties. The tie attaching wall hooks may suitably be alternatively magnetically attached to the oven's interior sidewalls. Preferably, such wall hooks are placed at an elevation within the microwave oven which requires that, upon extension and hooking of the ties, the ties extend angularly downwardly from the dasher. Provided that the ties are composed of the preferred elastic and stretchable material, spring forces exerted by the ties against the dasher advantageously downwardly hold the dasher within the vessel to maintain sliding contact at the dasher and vessel's rotary bearing surfaces. Upon rotary powered operation of the microwave oven's carousel, the vessel along with the liquid or semi-liquid food items contained within the vessel are rotated, while the ties' attachments to the microwave oven's walls dually function for constraining the dasher against rotation, and for holding bearing surfaces in sliding contact, resulting in an advantageous stirring action.

Where the food product which is heated within the vessel has a tendency for precipitation and collection of solids at the vessel's floor, the lower surfaces of the dasher advantageously further function as a floor scraping or wiping element.

Accordingly, objects of the instant invention include the provision of a microwave oven food stirring assembly which incorporates structures, as described above, and arranges those structures with respect to each other in manners described above, for performance of the beneficial functions described above.

Other and further objects, benefits, and advantages of the instant invention will become known to those skilled in the art upon review of the Detailed Description which follows, and upon review of the appended drawings.

### BRIEF DESCRIPTION OF THE DRAWINGS

FIG. 1 is a perspective view of the instant inventive microwave oven food stirring assembly.

FIG. 2 is a perspective view of a disassembled component of a dasher element of the instant inventive assembly.

FIG. 3 is a perspective view of a second disassembled component of the dasher element of the instant inventive assembly.

FIG. 4 is a perspective view of a third disassembled component of the dasher element of the instant inventive assembly.

FIG. 5 is an undersurface view of the dasher element of the instant inventive assembly.

### DETAILED DESCRIPTION OF A PREFERRED EMBODIMENT

Referring now to the drawings, and in particular to Drawing FIG. 1, a dasher element of the instant inventive microwave oven food stirring assembly is referred to generally by Reference Arrow 1. Referring further simultaneously to FIGS. 2 and 3, the lower portion of the dasher 1 preferably comprises a pair of plates 12 and 16. Upon assembly to assume the depicted configuration of the plates 12 and 16 (e.g., via mutual nesting interconnection of downwardly and upwardly opening slots 11 and 15), the dasher 1 presents four radially outwardly extending food stirring vanes. Such interconnection of plates 12 and 16 advantageously produces an “X” configuration of the lower portion of the dasher 1 which allows the dasher 1 to function as a base support structure for orienting the dasher 1 in an upright position with respect to vertical axis 3, and for preventing the dasher 1 from toppling during stirring use.

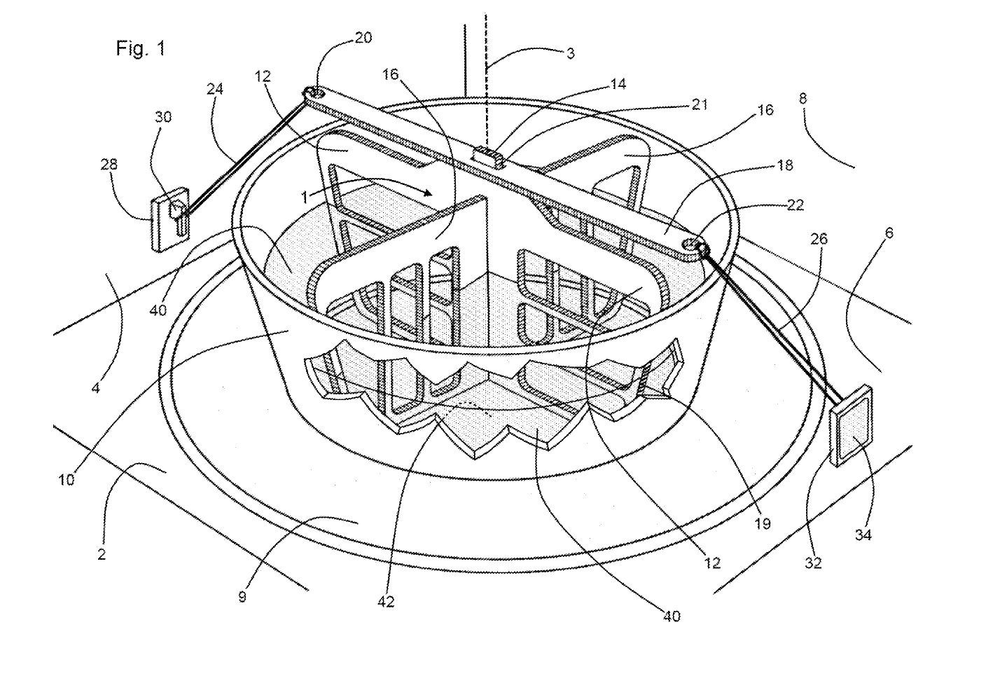

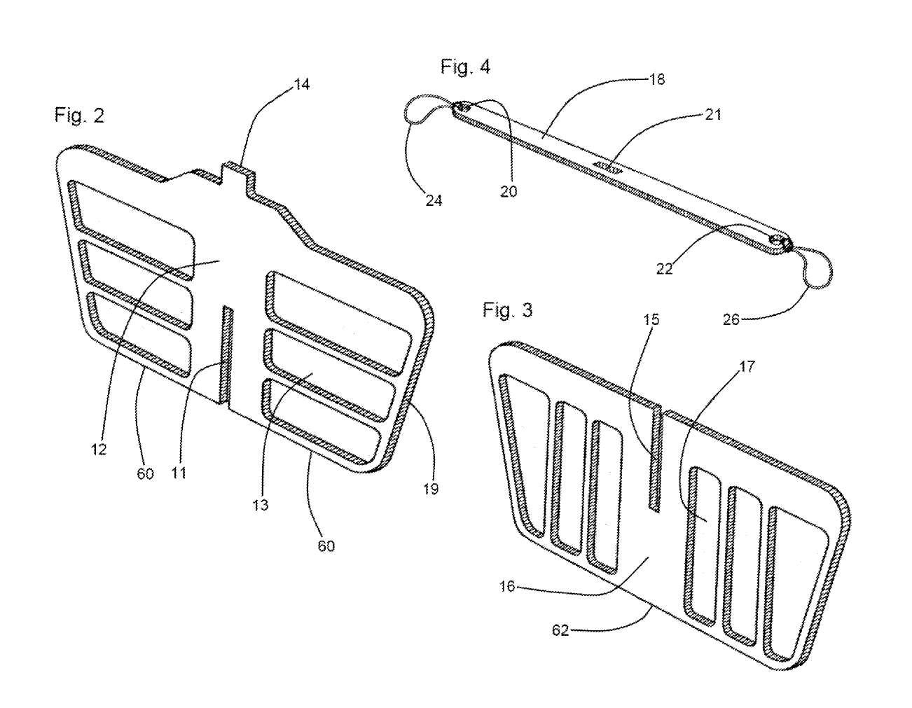

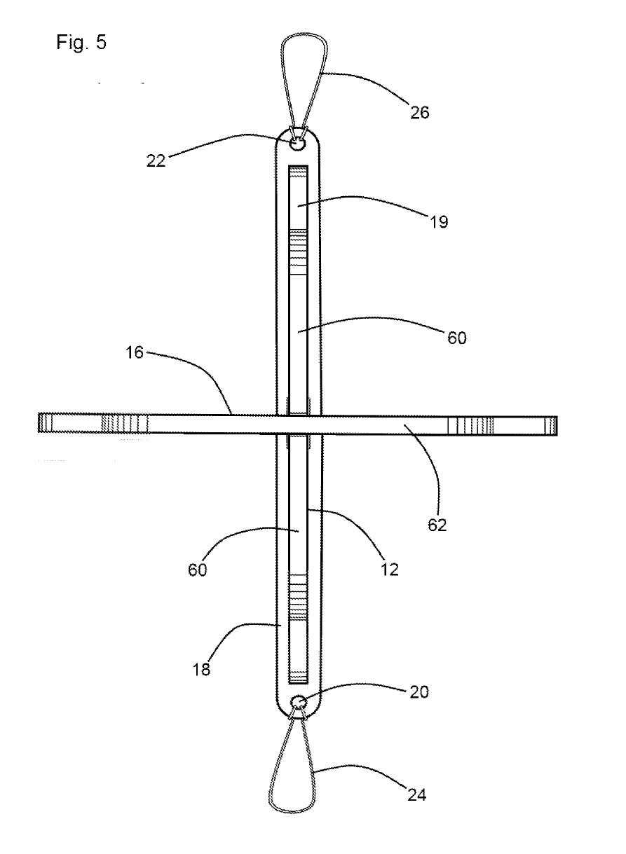

Referring simultaneously to FIGS. 1-4, the upper end of the assembly's dasher element 1 is preferably specially configured to present a “T” bracket 18, such bracket 18 having arms which cantilever radially and outwardly from axis 3. The dasher's “T” bracket component may be suitably alternatively fixedly and rigidly attached to or formed wholly with the lower and underlying portions of the dasher 1. However, as depicted, the “T” bracket 18 is preferably removably attached to the underlying portions of the dasher 1 by means of a pin and socket joint 14 and 21. The cross sectional profiles of such pin and socket joint components 14 and 21 are preferably non-circular (e.g., rectangular as depicted in FIGS. 1, 2, and 4) so that such joint may mechanically require that, upon fixing “T” bracket 18 against rotation about axis 3, the underlying portions of the dasher 1 are correspondingly fixed against rotation.

Referring to FIG. 5, a further structural component of the instant inventive microwave oven food stirring assembly comprises a rotary bearing 60,62, such bearing preferably comprising the undersurfaces of the dasher's plates 12 and 16. Referring further simultaneously to FIG. 1, the rotary bearing element of the inventive assembly preferably further comprises the upper surface 42 of the floor of a vessel 10. In operation of the assembly's rotary bearing element, bearing surfaces 42, 60, and 62 abut each other and slidably move in relation to each other. In operation, bearing surfaces 60 and 62 preferably remain fixed, and while bearing surface 42 preferably moves rotatably or orbitally with respect to surfaces 60 and 62. Direct slide bearing contact between bearing surfaces 60 and 62 and bearing surface 42 is preferred because such mode of contact allows the dasher element 1 to further advantageously function as a vessel floor scraper or wiper. Notwithstanding, other rotary bearing configurations such as ball bearings, roller bearings, and low friction skid pads (none depicted within views) may be suitably alternatively utilized. Preferably, all components of the dasher 1 are composed of a durable plastic which is both dishwasher safe and is microwave safe. Suitably, though less desirably, the dasher components may be composed of tempered glass, ceramics, wood, or a microwavable laminate composite material.

Referring to FIGS. 1, 4, and 5, a further structural component of the instant inventive microwave oven food stirring assembly comprises rotation stopping members, such members preferably comprising a plurality of, and preferably a pair of ties 24 and 26. Each of the ties preferably has its proximal end fixedly and removably attached to the distal end of one of the “T” bracket's arms by means of a larkshead knot which engages one of the eyes 20 and 22. Preferably, the ties 24 and 26 are composed of a dishwasher safe and microwave safe elastomeric material such as latex or rubber bands.

In use of the instant inventive microwave oven food stirring assembly, and referring in particular to FIG. 1, a microwave safe vessel 10 is preferably partially filled with a liquid or semi-liquid food product 40. Thereafter, the assembly's dasher component 1 may be downwardly inserted into and nestingly received within the interior space which is peripherally defined by the circular wall of the vessel 10. Thereafter, rotating and rotation resisting means are preferably provided for operation with respect to the dasher 1, vessel 10, and food product 40 assembly. In the depicted preferred embodiment, such rotating and rotation resisting means comprises a carousel turntable 9 which is a rotatably driven component of a common household microwave oven, such oven having a floor 2, left and right side walls 4 and 6, and a back wall 8.

Referring to all figures, the rotating and rotation resisting means preferably further comprise left and right wall mounted hooks 28,30 and 32,34. Such hooks are preferably securely adhesively mounted upon the microwave oven's interior sidewalls 4 and 6 at interior elevations below or underlying the elevation of the upper end of the dasher 1. Upon such mounting of hooks 28,30 and 32,34, outward and downward extensions and attachments of ties 24 and 26 to such hooks advantageously draw the dasher 1 downwardly, causing rotary bearing surfaces 60 and 62 to firmly and securely press against the rotary bearing surface 42 of vessel 10.

Referring to FIG. 1, upon operation of the microwave oven to rotate the turntable carousel 9, static friction existing between the undersurface of vessel 10 and the upper surface of the carousel 9 causes the vessel 10 to rotate with carousel 9 and simultaneously causes the liquid or semi-liquid food 40 contained within the vessel 10 to circulate. The anchoring attachments of ties 24 and 26 at hooks 28,30 and 32,34 advantageously resists translation of the rotating movement of the carousel 9, the vessel 10, and the food 40 to the dasher 1, causing the dasher 1 to continuously stir the food 40 while the elastic tension exerted by ties 24 and 26 assures that the undersurfaces 60 and 62 of the dasher 1 and the floor 42 of the vessel 10 continue to perform their rotary bearing function.

Flow-through ports 13 and 17 enhance the agitating and food stirring action of the dasher 1. To further enhance stirring action, at least a first radially outer edge 19 of the dasher 1 is preferably fitted to closely orbit over the inner surface of the peripheral wall of the vessel 10, such close fitting advantageously allowing the dasher 1 to stir the portions of the food product 40 which may reside near such peripheral vessel wall.

While the principles of the invention have been made clear in the above illustrative embodiment, those skilled in the art may make modifications in the structure, arrangement, portions and components of the invention without departing from those principles. Accordingly, it is intended that the description and drawings be interpreted as illustrative and not in the limiting sense, and that the invention be given a scope commensurate with the appended claims.

I claim:

1. A microwave oven food stirring assembly comprising:
(a) a dasher having an upper end, and having a lower surface;
(b) a rotary bearing, the rotary bearing comprising the dasher's lower surface; and
(c) rotation stopping members, the rotation stopping members being fixedly attached to the dasher's upper end.

2. The microwave oven food stirring assembly of claim 1 wherein the dasher's upper end comprises a “T” bracket and bracket mounting means, the bracket mounting means fixedly attaching the “T” bracket at the dasher's upper end, and wherein the rotation stopping members comprise a plurality of ties, each tie having a proximal end fixedly attached to the “T” bracket.

3. The microwave oven food stirring assembly of claim 2 wherein the “T” bracket has a plurality of arms, each arm among said plurality of arms having a distal end, each tie's fixed attachment positioning said each tie's proximal end at one of said arms' distal ends.

4. The microwave oven food stirring assembly of claim 3 wherein the dasher has a vertical axis, and wherein the dasher comprises a plurality of vanes.

5. The microwave oven food stirring assembly of claim 4 wherein the vanes are arranged in an “X” base configuration.

6. The microwave oven food stirring assembly of claim 5 wherein the “T” bracket's removable attachment positions the “T” bracket's arms for cantilevering extensions from the dasher's vertical axis.

7. The microwave oven food stirring assembly of claim 6 wherein each vane among the plurality of vanes has at least a first flow through port.

8. The microwave oven food stirring assembly of claim 3 wherein the “T” bracket's removable attachment comprises a non-circular pin and socket joint.

9. The microwave oven food stirring assembly of claim 3 wherein each tie comprises an elastomeric band.

10. The microwave oven food stirring assembly of claim 2 wherein the dasher is composed of a microwave oven safe material selected from the group of plastics, glass, ceramics, laminate composites, and wood.

11. The microwave oven food stirring assembly of claim 1 wherein the rotary bearing further comprises a vessel floor surface, the rotary bearing's lower dasher and vessel floor surfaces being held by the ties in contact with each other.

12. The microwave oven food stirring assembly of claim 11 wherein the vessel further comprises an interior space defined by a peripheral wall, the interior space nestingly receiving the dasher.

13. The microwave oven food stirring assembly of claim 12 wherein the dasher further comprises a plurality of radially outer surfaces, wherein the vessel's peripheral wall comprises a radially inner surface, and wherein said radially outer and radially inner surfaces are closely fitted to each other.

14. The microwave oven food stirring assembly of claim 13 further comprising rotating and rotation resisting means connected operatively to the vessel and to the ties' distal ends, the rotating and rotation resisting means being adapted for simultaneously rotating the vessel and resisting rotation of the dasher.

15. The microwave oven food stirring assembly of claim 14 wherein the rotating and rotation resisting means comprise a plurality of hooks, each hook being adapted for releasable attachment to one of the ties' distal ends.

16. The microwave oven food stirring assembly of claim 15 wherein the rotating and rotation resisting means comprise a microwave oven carousel, said carousel having vessel supporting turntable.

17. The microwave oven food stirring assembly of claim 16 wherein the hooks are positioned on the microwave oven's side walls for extending the ties downwardly and outwardly from the dasher's upper end.

18. The food stirring assembly of claim 17 wherein the ties are elastically tensioned.
